(19) United States
(12) Patent Application Publication
(10) Pub. No.: US 2019/0012667 A1
(43) Pub. Date: Jan. 10, 2019

(54) BANKING PAYMENT SYSTEM BY USING BODY INFORMATION WITHOUT CARD AND METHOD THEREOF

(71) Applicant: STC Limited Corp., Seongnam-si (KR)

(72) Inventor: Hyesun SONG, Seongnam-si (KR)

(21) Appl. No.: 15/664,567

(22) Filed: Jul. 31, 2017

(30) Foreign Application Priority Data
Jul. 5, 2017 (KR) 10-2017-0085350

(51) Int. Cl. G06Q 20/40; G06Q 20/10

(52) U.S. Cl. CPC G06Q 20/405; G06Q 20/108; G06Q 20/4014

(57) ABSTRACT

A banking payment method using body information without card includes: saving banking transaction information on a server of a financial institution; receiving customer's password by a device of a member store connected to the server and sending the password to the server; confirming password by the server and sending facial recognition information of the customer to the device; taking a photo of the customer by a camera attached to the device and sending photo information to the device; extracting facial recognition information from image information by the device; comparing the extracted facial recognition information and previously saved facial recognition information by the device; displaying product information by the device if facial recognition information agrees; sending serial number information of the device and product information to the server; processing banking transactions using banking transaction information; and sending the result of banking transaction to the device.

### CROSS REFERENCE TO RELATED APPLICATION

This application claims priority to Korean Patent Application No. 10-2017-0085350, filed Jul. 5, 2017, which is hereby incorporated by reference in its entirety.

### BACKGROUND OF THE INVENTION

### 1. Field of the Invention

This invention relates to a banking payment system that uses body information without credit card. Current banking transactions involve the use of password authentications like security card and OTP, and there are limitations in preventing wrongful banking transactions due to loss of security card or OTP and piracy of resident registration number. In addition, unlawful banking transactions often occur from loss of bankbook and personal seal or hacking of password.

### 2. Description of Related Art

The conventional art related to this invention is described in Korean Patent Application Publication No. 10-2005-0111653 (published on Nov. 28, 2005). FIG. 1 is a block diagram of the conventional payment system that uses facial picture information of customer. In FIG. 1, the conventional payment system using facial picture information of customer is a payment system that uses a wired or wireless client device (200) with picture input method, comprised of a wired or wireless client device (200) and a payment processing and/or payment approval server (205). Desirably, the wired or wireless client device (200) uses the prescribed picture input method to read facial picture information of the customer making the prescribed payment and sends this facial picture information to the prescribed payment processing and/or payment approval server (205). For example, the wired or wireless client device (200) may include the prescribed picture input method (for instance, internal or external digital camera, etc.) that receives facial picture of the customer. For instance, the picture input method above may be a device with CCD (Charge Coupled Device) that receives input of real image in the form of 2-dimensional array of digital pixels. For instance, a wired client device with picture input method may be a client device attached with a web camera, and a wireless client device with picture input method may be a camera phone attached with a CDMA (Code Division Multiple Access) core chip of MSM 5100/5500 or higher made by Qualcomm, U.S. When reading the prescribed facial picture information of the customer entered using the picture input method above, the wired or wireless client device (200) may use the method based on regional characteristics of facial components which determines face using unique facial characteristics and compositions such as eyes, nose and mouth [U.S. Pat. No. 5,659,625, KR2000-0004193], the method of using overall facial shape by analyzing primary components instead of dividing face into parts [JP2000-113197], etc. In addition, the wired or wireless client device (200) uses the prescribed wired or wireless network to connect the service (205) above to a communication session and sends facial picture information of the customer to the payment processing and/or payment approval server (205) via the communication session above. Desirably, the payment processing and/or payment approval server (205) registers and saves facial picture information received from the wired or wireless client device (200) above on a storage medium (210) by linking picture information with payment information and/or payment approval information of the customer. In addition, when checking illegal use of payment methods by the client above, the payment processing and/or payment approval server (205) above extracts facial picture information of the client using the payment methods, linked with payment information and/or payment approval information and saved on the storage medium (210) above, and determines illegal use of the payment methods by the client above. For instance, the payment methods above should desirably include credit card payment, debit card payment, check card payment, prepaid card payment, and/or banking network payment.

### SUMMARY OF THE INVENTION

The conventional payment system using facial picture information stores picture information on a storage medium and has a concern for loss of the storage medium, where stored facial picture information can be deleted and replaced by facial picture information of illegal acquirer. Therefore, this invention is intended to resolve the difficulty of individuals in managing their facial picture information and to ensure safe banking transaction of customers without concerns for hacking and security issue. In addition, another purpose of this invention is to allow for convenient payment at member stores without credit card.

The banking payment method using body information without card includes a step in which banking transaction information such as password, device serial number information of member store, facial recognition information of customer, bank account number information, name of customer, account balance, name of member store owner, and bank account number information of member store owner is saved and registered on a server of a financial institution, a step in which a device of a member store connected to the server of the financial institution receives customer's password input and sends it to the server, a step in which the server of the financial institution confirms password and sends facial recognition information of the customer to the device of the member store to be saved, a step in which a camera attached to the device of the member store takes a photo of the customer and sends photo information to the device of the member store, a step in which the device of the member store extracts facial recognition information from image information, a step in which the device of the member store compares facial recognition information extracted from the photo and facial recognition information saved previously, a step in which the device of the member store displays product information such as name, price and quantity of product using display area of the device of the member store if facial recognition information agrees, a step in which the device of the member store sends serial number information of the device and product information to the server of the financial institution, a step in which the server of the financial institution processes banking transactions like account transfer using banking transaction information, and a step in which the server of the financial institution sends the result of banking transaction to a designated device of the customer and a designated device of the member store owner.

### Advantageous Effects

The banking payment system using body information without card and method thereof can effectively reduce management cost by removing the need for transaction security methods like bankbook and security card. Moreover, the banking payment system and method can fundamentally prevent illegal transactions like hacking by using body information as a means of authentication. In addition, the banking payment system and method can reduce commission fees from credit card transactions.

### BRIEF DESCRIPTION OF DRAWINGS

FIG. 1 is a block diagram of the conventional payment system that uses facial picture information of customer.

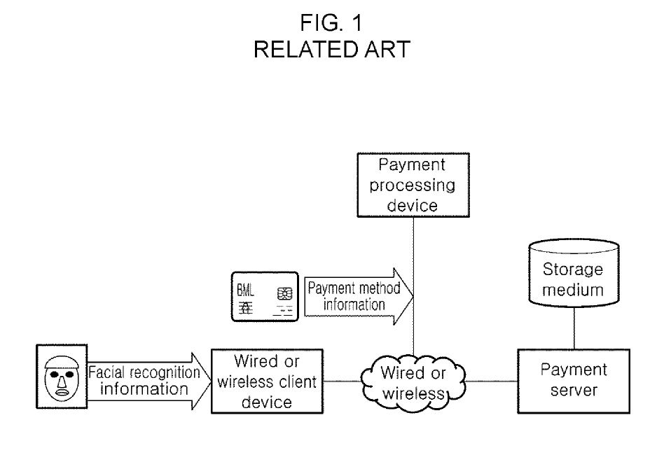

FIG. 2 is a block diagram showing the first embodiment of the banking payment system of this invention that uses body information without card.

FIG. 3 is a flow chart showing the first embodiment of the banking payment method of this invention that uses body information without card.

FIG. 4 is a block diagram showing the second embodiment of the banking payment system of this invention that uses body information without card.

FIG. 5 is a flow chart showing the second embodiment of the banking payment method of this invention that uses body information without card.

### DETAILED DESCRIPTION OF THE INVENTION

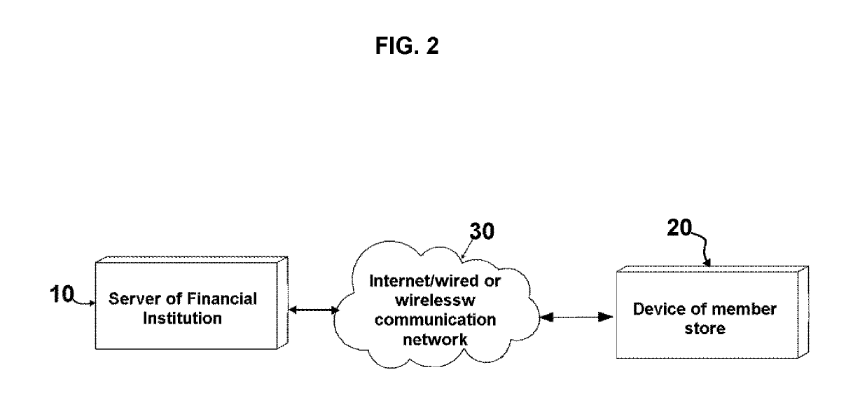

The banking payment system of this invention that uses body information without card and method thereof can be explained using FIGS. 2 through 5 as below.

FIG. 2 is a block diagram showing the first embodiment of the banking payment system of this invention that uses body information without card. In FIG. 2, the first embodiment of the banking payment system of this invention that uses body information without card comprises: a server of a financial institution (10) that saves and registers banking transaction information such as password of a customer, facial recognition information, device serial number information of a member shop, bank account number information, name of the customer, account balance, bank account number information of the member store owner and name of the member store owner, receives password entered by the customer from a device of the member store, compares it with password saved previously, sends facial recognition information of the customer if passwords agree, receives product information and device serial number from the device of the member store, processes banking transactions such as account transfer, and sends the result of banking transaction to the device of the member store; a device of a member store (20) that is connected to the server of the financial institution and equipped with a camera, receives image information of the customer from the camera, extracts facial recognition information from image information received, receives password input from the customer, sends it to the server of the financial institution, compares facial recognition information extracted and facial recognition information saved previously, receives and sends product information to the server of the financial institution along with device serial number of the member store, and receives the result of banking transaction from the server of the financial institution; and internet, wired or wireless communication network (30) that connects the server of the financial institution and the device of the member store by the network. In the above, facial recognition information can be replaced by body information such as pupil information or fingerprint information of the customer. In the above, connection of the device of the member store to the server of the financial institution refers to the state in which the device is connected to a website on the server of the financial institution through authentication using ID and password. If there are many financial institutions, the member store owner uses enters ID and password into the device of the member store to connect to the server of the financial institution designated by the customer. In addition, when saving and registering password of the customer with the financial institution, it can be saved and registered along with financial institution information so that the device of the member store can automatically connect to the server of the respective financial institution only using password of the customer. In addition, the server of the financial institution can accumulate and save the results of banking transactions for a given period and periodically send the results for the given period to the devices designated by the customer and the member store owner. In the above, the result of transaction may include name of product, price and quantity of product, date and time of transaction, bank account number of the customer and bank account number of the member store owner, and payment is automatically made from bank account number of the customer to bank account number of the member store owner upon purchase.

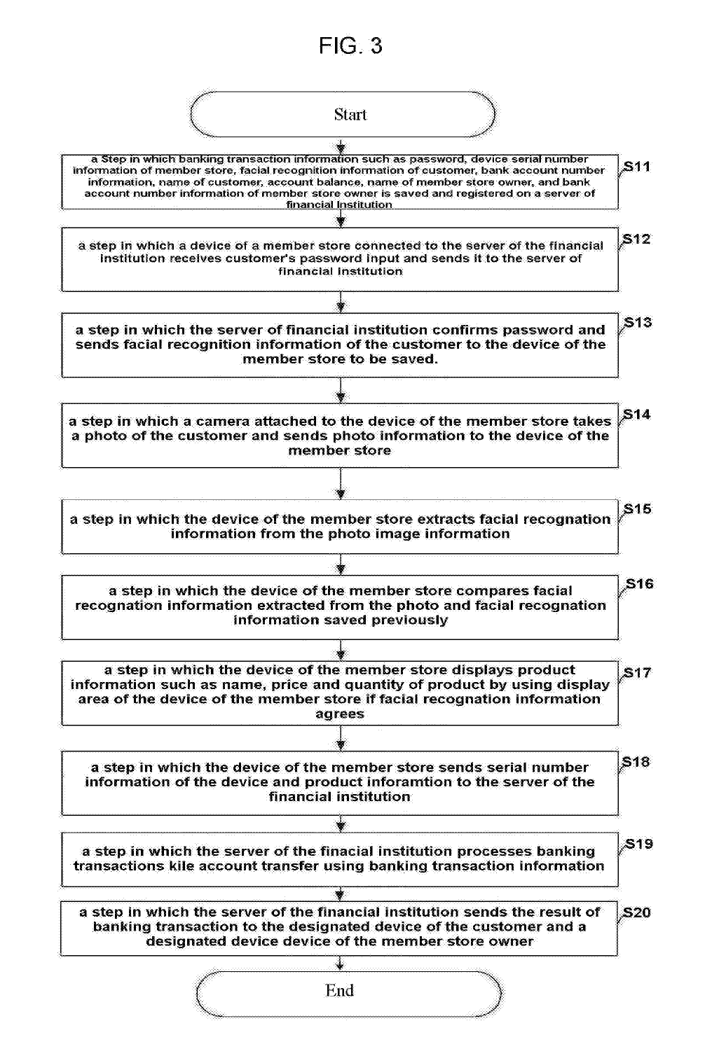

FIG. 3 is a flow chart showing the first embodiment of the banking payment method of this invention that uses body information without card. In FIG. 3 above, the first embodiment of the banking payment method of this invention using body information without card includes a step (S11) in which banking transaction information such as password, device serial number information of member store, facial recognition information of customer, bank account number information, name of customer, account balance, name of member store owner, and bank account number information of member store owner is saved and registered on a server of a financial institution, a step (S12) in which a device of a member store connected to the server of the financial institution receives customer's password input and sends it to the server, a step (S13) in which the server of the financial institution confirms password and sends facial recognition information of the customer to the device of the member store to be saved, a step (S14) in which a camera attached to the device of the member store takes a photo of the customer and sends photo information to the device of the member store, a step (S15) in which the device of the member store extracts facial recognition information from image information, a step (S16) in which the device of the member store compares facial recognition information extracted from the photo and facial recognition information saved previously, a step (S17) in which the device of the member store displays product information such as name, price and quantity of product using display area of the device of the member store if facial recognition information agrees, a step (S18) in which the device of the member store sends serial number information of the device and product information to the server of the financial institution, a step (S19) in which the server of the financial institution processes banking transactions like account transfer using banking transaction information, and a step (S20) in which the server of the financial institution sends the result of banking transaction to a designated device of the customer and a designated device of the member store owner. In addition, in S13 above, authentication failure information is sent to the device of the member store before exiting if information does not agree. In addition, in S16 above, discordance information is provided through display area on the device of the member store if information does not agree. In the above, the designated device may be a device of the member store.

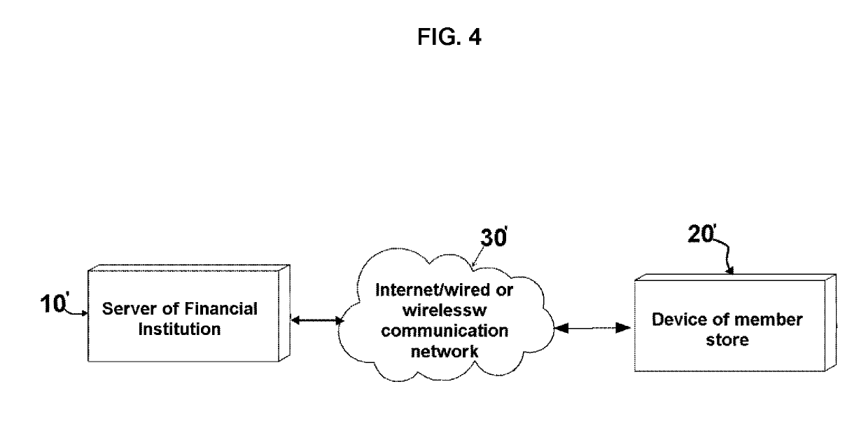

FIG. 4 is a block diagram showing the second embodiment of the banking payment system of this invention that uses body information without card. In FIG. 4, the second embodiment of the banking payment system of this invention that uses body information without card is comprised of: A server of a financial institution (10′) that saves and registers banking transaction information such as password of a customer, facial recognition information, bank account number information, name of the customer, account balance, bank account number information of the member store owner and name of the member store owner, receives password entered by the customer from a device of the member store, compares it with password saved previously, sends the authentication result to the device of the member store, receives facial recognition information, product information, and device serial number of the member store from the device of the member store, compares facial recognition information received and facial recognition information saved previously, processes banking transactions such as account transfer, and sends the result of banking transaction to the device of the member store; a device of a member store (20′) connected to the server of the financial institution and attached with a camera that receives image information of the customer from the camera, extracts facial recognition information from image information received, receives password input from the customer, sends it to the server of the financial institution, receives the authentication result from the server of the financial institution, sends facial recognition information extracted, product information entered, and device serial number information to the server of the financial institution, and receives the result of banking transaction from the server of the financial institution; and internet, wired or wireless communication network (30′) that connects the server of the financial institution and the device of the member store by the network. In the above, facial recognition information can be replaced by body information such as pupil information or fingerprint information of the customer. In the above, connection of the device of the member store to the server of the financial institution refers to the state in which the device is connected to a website on the server of the financial institution through authentication using ID and password. If there are many financial institutions, the member store owner uses enters ID and password into the device of the member store to connect to the server of the financial institution designated by the customer.

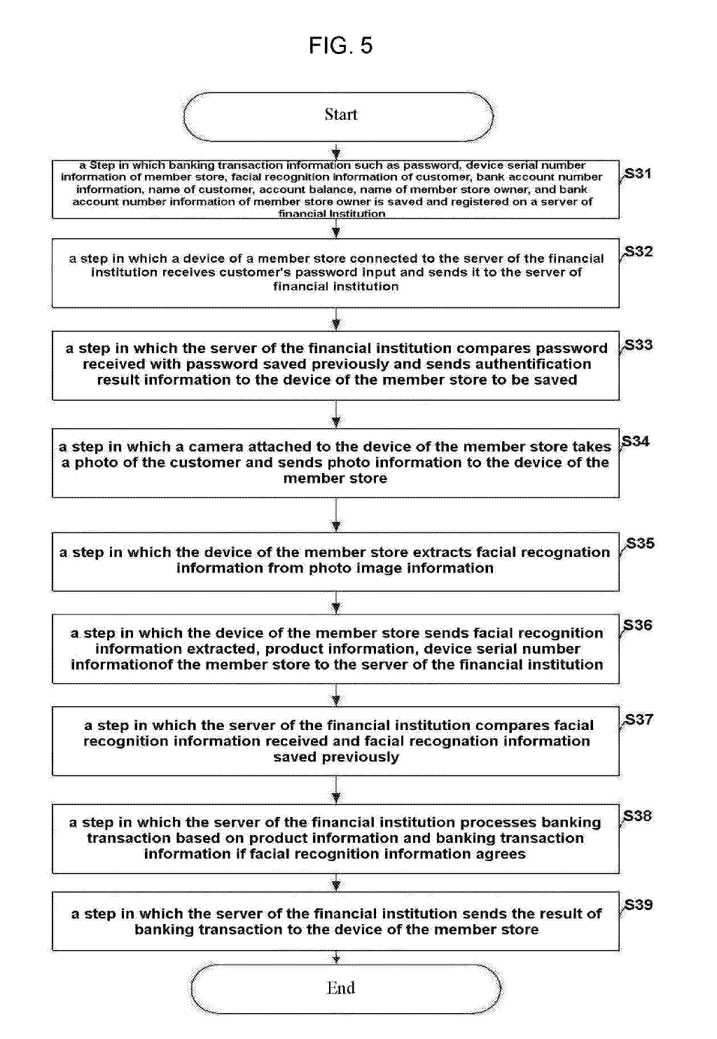

FIG. 5 is a flow chart showing the second embodiment of the banking payment of this invention that uses body information without card. In FIG. 5, the second embodiment of the banking payment method of this invention that uses body information without card a step (S31) in which banking transaction information such as password of a customer, facial recognition information, bank account number information, name of the customer, account balance, bank account number information of the member store owner, name of the member store owner, and device serial number information of the member store is saved and registered on a server of a financial institution, a step (S32) in which a device of a member store connected to the server of the financial institution receives customer's password input and sends it to the server, a step (S33) in which the server of the financial institution compares password received with password saved previously and sends authentication result information to the device of the member store to be saved, a step (S34) in which a camera attached to the device of the member store takes a photo of the customer and sends photo information to the device of the member store, a step (S35) in which the device of the member store extracts facial recognition information from image information, a step (S36) in which the device of the member store sends facial recognition information extracted, product information, and device serial number information of the member store to the server of the financial institution, a step (S37) in which the server of the financial institution compares facial recognition information received and facial recognition information saved previously, a step (S38) in which the server of the financial institution processes banking transaction based on product information and banking transaction information if facial recognition information agrees, and a step (S39) in which the server of the financial institution sends the result of banking transaction to the device of the member store. In addition, in S33 above, authentication failure information is sent to the device of the member store before exiting if information does not agree. In S37 above, banking transaction is stopped and transaction failure information is sent to the device of the member store if information does not agree.

Although the embodiments of the present invention have been disclosed for illustrative purposes, those skilled in the art will appreciate that various modifications, additions and substitutions are possible, without departing from the scope and spirit of the invention. For example, if the described techniques are performed in a different order, if the described components, such as systems, architectures, devices, and circuits, are combined or coupled with other components by a method different from the described methods, or if the described components are replaced with other components or equivalents, the results are still to be understood as falling within the scope of the present invention.

1. A banking payment system that uses body information without card, comprising:
a server of a financial institution (10) that:
saves and registers banking transaction information including customer password, facial recognition information, device serial number of a device of a member store, bank account number, customer name, account balance, bank account number of the member store owner, and name of the member store owner,
receives password entered by the customer from the device of the member store,
compares the received password with the customer password saved previously,
sends the facial recognition information of the customer if the passwords match,
receives product information and the device serial number from the device of the member store,
processes banking transactions including account transfer,
sends results of the banking transactions to the device of the member store, and
accumulates and saves the results of the banking transactions for a given period and periodically sends the results for the given period to devices designated by the customer;
a device of a member store (20) that:
is connected to the server of the financial institution and equipped with a camera,
receives image information of the customer from the camera,
extracts facial recognition information from the received image information,
receives the password input from the customer, and sends the password to the server of the financial institution,
compares the extracted facial recognition information and the facial recognition information saved previously,
receives and sends product information to the server of the financial institution along with the device serial number of the member store, and
receives the results of the banking transactions from the server of the financial institution; and
internet, wired or wireless communication network (30) that connects the server of the financial institution and the device of the member store.

2. (canceled)

3. A banking payment system that uses body information without card, comprising:
a server of a financial institution (10′) that:
saves and registers banking transaction information including customer password, facial recognition information, bank account number, customer name, account balance, bank account number of a member store owner, and name of the member store owner,
receives password entered by the customer from a device of the member store,
compares the received password with the customer password saved previously to authenticate the customer, and sends the authentication result to the device of the member store,
receives facial recognition information, product information, and device serial number of the device of the member store from the device of the member store,
compares the received facial recognition information and the facial recognition information saved previously,
processes banking transactions including account transfer,
sends results of the banking transactions to the device of the member store, and
accumulates and saves the results of banking transactions for a given period and periodically sends the results for the given period to devices designated by the customer;
a device of a member store (20′) that:
is connected to the server of the financial institution and equipped with a camera,
receives image information of the customer from the camera,
extracts facial recognition information from the received image information,
receives the password input from the customer, and sends the password to the server of the financial institution,
receives the authentication result from the server of the financial institution,
sends the extracted facial recognition information, the entered product information, and the device serial number information to the server of the financial institution, and
receives the results of the banking transactions from the server of the financial institution; and
internet, wired or wireless communication network (30′) that connects the server of the financial institution and the device of the member store.

4. (canceled)

5. A banking payment method that uses body information without card, comprising:
a step (S11) in which banking transaction information including customer password, device serial number of a device of a member store, facial recognition information of customer, bank account number, customer name, account balance, name of member store owner, and bank account number of member store owner, is saved and registered on a server of a financial institution;
a step (S12) in which a device of a member store connected to the server of the financial institution receives customer password input by the customer and sends the password to the server of the financial institution;
a step (S13) in which the server of the financial institution checks if the passwords match, and sends the facial recognition information of the customer to the device of the member store if the passwords match, so that the device of the member store saves the facial recognition information;
a step (S14) in which a camera attached to the device of the member store takes an image of the customer and sends the image information to the device of the member store;
a step (S15) in which the device of the member store extracts facial recognition information from the image information;
a step (S16) in which the device of the member store compares the extracted facial recognition information and the facial recognition information saved previously;
a step (S17) in which the device of the member store displays product information including name, price and quantity of product, using a display area of the device of the member store if both of the facial recognition information match;
a step (S18) in which the device of the member store sends device serial number of the device and the product information to the server of the financial institution;
a step (S19) in which the server of the financial institution processes banking transactions including account transfer, using the banking transaction information; and
a step (S20) in which the server of the financial institution sends results of the banking transactions to a designated device of the customer and a designated device of the member store owner.

6. The banking payment method of claim 5, wherein in the step (S13), if the passwords do not match, authentication failure information is sent to the device of the member store before exiting.

7. The banking payment method of claim 5, wherein in the step (S16), if both of the facial recognition information do not match, mismatch information is provided through the display area of the device of the member store before exiting.

8. A banking payment method that uses body information without card, comprising:
a step (S31) in which banking transaction information including customer password, facial recognition information, bank account number, customer name, account balance, bank account number of member store owner, name of the member store owner, and device serial number of a device of the member store, is saved and registered on a server of a financial institution;
a step (S32) in which a device of a member store connected to the server of the financial institution receives customer password input by the customer and sends the password to the server of the financial institution;
a step (S33) in which the server of the financial institution compares the received password with the customer password saved previously, and sends an authentication result to the device of the member store so that the device of the member store saves the authentication result;
a step (S34) in which a camera attached to the device of the member store takes an image of the customer and sends the image information to the device of the member store;
a step (S35) in which the device of the member store extracts facial recognition information from the image information;
a step (S36) in which the device of the member store sends the extracted facial recognition information, product information, and device serial number of the device of the member store to the server of the financial institution;
a step (S37) in which the server of the financial institution compares the received facial recognition information and the facial recognition information saved previously;
a step (S38) in which the server of the financial institution processes banking transactions based on the product information and the banking transaction information if both of the facial recognition information match; and
a step (S39) in which the server of the financial institution sends results of the banking transactions to the device of the member store.

9. The banking payment method of claim 8, wherein in the step (S33), if the passwords do not match, authentication failure information is sent to the device of the member store before exiting.

10. The banking payment method of claim 8, wherein in the step (S37), if both of the facial recognition information do not match, the banking transactions are stopped and transaction failure information is sent to the device of the member store.
